(19) United States
(12) Patent Application Publication
(10) Pub. No.: US 2007/0279605 A1
(43) Pub. Date: Dec. 6, 2007

(54) Exposure systems including devices for inhibiting heating caused by infrared radiation from vacuum pump or the like

(75) Inventor: Shintaro Kawata, Moriya-shi (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/789,781

(22) Filed: Apr. 24, 2007

Related U.S. Application Data
(60) Provisional application No. 60/854,853, filed on Oct. 26, 2006.

(30) Foreign Application Priority Data
Apr. 25, 2006 (JP) 2006-120743

(51) Int. Cl. G03B 27/42; G03C 5/16

(52) U.S. Cl. 355/30; 355/53; 430/269

(57) ABSTRACT

Exposure systems are disclosed that suppress incidence of infrared radiation from a vacuum pump into a chamber in which exposures are performed under vacuum. An exemplary system includes a chamber, a vacuum pump, an evacuation duct connecting the pump to the chamber, and an infrared-radiation propagation-inhibiting device. The chamber accommodates “exposure components” of the exposure system. The vacuum pump evacuates gas from the chamber. The infrared-radiation propagation-inhibiting device is situated, for example, in the chamber, in an inlet from the chamber into the evacuation duct, and/or in the evacuation duct itself, and impedes the incidence of infrared radiation from the pump into the chamber.

### CROSS REFERENCE TO RELATED APPLICATIONS

This application claims priority to, and claims the benefit of, U.S. Provisional Application No. 60/854,853, filed on Oct. 26, 2006, which claims priority under 35 U.S.C. §119(a) to prior Japan Patent Application No. 2006-120743, filed on Apr. 25, 2006, both of which are incorporated herein by reference in their entirety.

### FIELD

This disclosure pertains to, inter alia, exposure systems, such as microlithography systems, that are operated in a vacuum environment. More specifically, the disclosure pertains to devices and methods for at least inhibiting incursion of radiative heat, produced by a vacuum pump or the like, into an area of the system where actual exposure is occurring.

### BACKGROUND

The reduced dimensions of active elements in semiconductor integrated circuits in recent years have been accompanied by (and have driven) the development of several types of lithography systems that are performed in “vacuum” environments. One such system is an extreme ultraviolet (EUV) exposure system that uses EUV light, having a wavelength of approximately 1 to 50 nm, as an exposure light. Another such system is a charged-particle-beam (CPB) exposure system that uses a charged particle beam (e.g., electron beam) as an exposure energy beam. Both systems were developed to achieve further improvement in the resolution of previous projection-optical systems that were limited by optical diffraction limits. An example of such an exposure system is described in Japan Unexamined Patent Application No. 2005-203754.

The various EUV exposure systems and CPB exposure systems comprise a projection-optical system, a stage for an “original-plate” (e.g., reticle or mask or other “plate” that defines a pattern master), a stage for a “sensitive substrate” (plate onto which the pattern is to be transferred from the original plate), and typically an illumination-optical system, as well as other “exposure components.” These exposure components are generally placed and used in a vacuum environment established in a chamber. The vacuum environment is required to prevent the exposure beam (EUV light or charged particle beam) from being absorbed by and/or attenuated by passage through air. The chamber is connected via an evacuation conduit to a “dry” pump, or other type of pump (including multiple pumps) used for evacuating the chamber.

In the exposure system, if the wafer, the reticle, the optical elements, and/or other exposure components experience thermal deformation during exposure, then exposure accuracy and precision are unacceptably reduced. Hence, there is a need to control the temperatures of each of these components in the chamber with extremely high precision.

During analysis of various undesirable phenomena occurring during exposures made in EUV and CPB exposure systems, it was discovered that infrared radiation generated in or by a dry pump or other vacuum pump propagates from the pump along the evacuation conduit into the chamber. In the chamber the radiation is incident on any of various exposure components and causes heating of the components within the chamber. This heating, if uncontrolled or not prevented, can be a source of significant error in exposure accuracy.

### SUMMARY

The problem noted above is addressed by methods and devices as disclosed herein. More specifically, the instant methods and devices, as incorporated into an exposure system, suppress the incidence of infrared radiation from a dry pump or other pump onto critical components in the vacuum chamber.

According to one aspect, exposure systems are provided. An embodiment of such an exposure system comprises a chamber, a vacuum pump (e.g., a dry pump), an evacuation duct, and an infrared-radiation propagation-inhibiting device. The chamber accommodates components of the exposure system. The pump evacuates gas from within the chamber. The evacuation duct connects the chamber and the pump. The infrared-radiation propagation-inhibiting device can be situated in the chamber, at or in an inlet of the duct opening into the chamber, and/or in the evacuation duct itself. The infrared-radiation propagation-inhibiting device prevents incidence of infrared radiation from the pump into the chamber.

The various embodiments disclosed herein prevent or suppress temperature increases in components in of exposure system that otherwise would be caused by the incidence of infrared radiation from the vacuum pump into the chamber.

### BRIEF DESCRIPTION OF THE DRAWINGS

FIG. 1 is a schematic elevational view of a wafer-chamber portion of an exposure system, according to a first representative embodiment.

FIG. 2 is a schematic optical diagram of an embodiment of an EUV exposure system.

FIG. 3 schematically depicts an enlarged view of a portion of an interior surface of an evacuation duct.

FIG. 4 is a schematic elevational view of a wafer-chamber portion of an exposure system, according to a second representative embodiment.

FIG. 5 is a schematic elevational view of a wafer-chamber portion of an exposure system, according to a third representative embodiment.

FIG. 6 is a schematic elevational view of a wafer-chamber portion of an exposure system, according to a fourth representative embodiment.

FIG. 7 is a plan view of an exemplary configuration of a shielding member used in the embodiment of FIG. 6.

FIG. 8 is a cross-sectional view along the line A-A in FIG. 7.

FIG. 9 is a schematic elevational view of a wafer-chamber portion of an exposure system, according to an alternative configuration of the embodiment of FIG. 6.

FIG. 10 is a schematic elevational view of a wafer-chamber portion of an exposure system, according to a fifth representative embodiment.

FIG. 11 is a schematic elevational diagram of an exemplary charged-particle-beam (CPB) exposure system.

### DETAILED DESCRIPTION

The following disclosure is set forth in the context of representative embodiments that are not intended to be limiting in any way.

### First Representative Embodiment

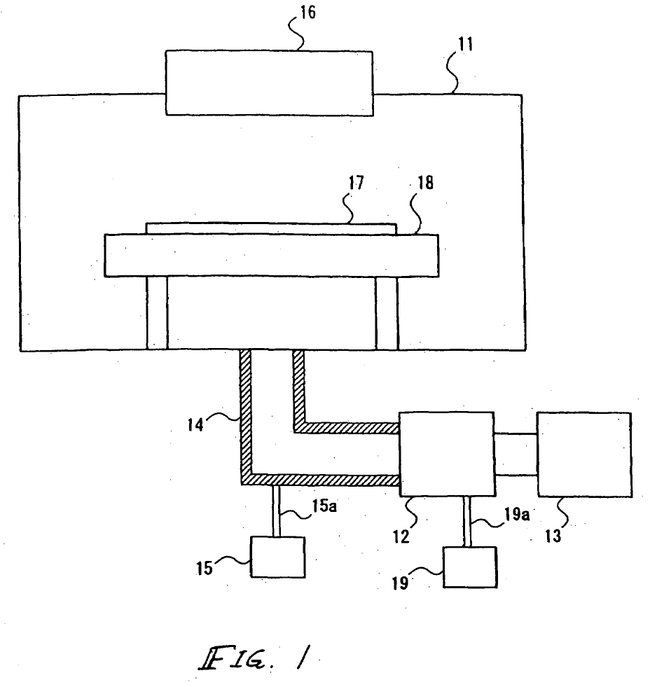

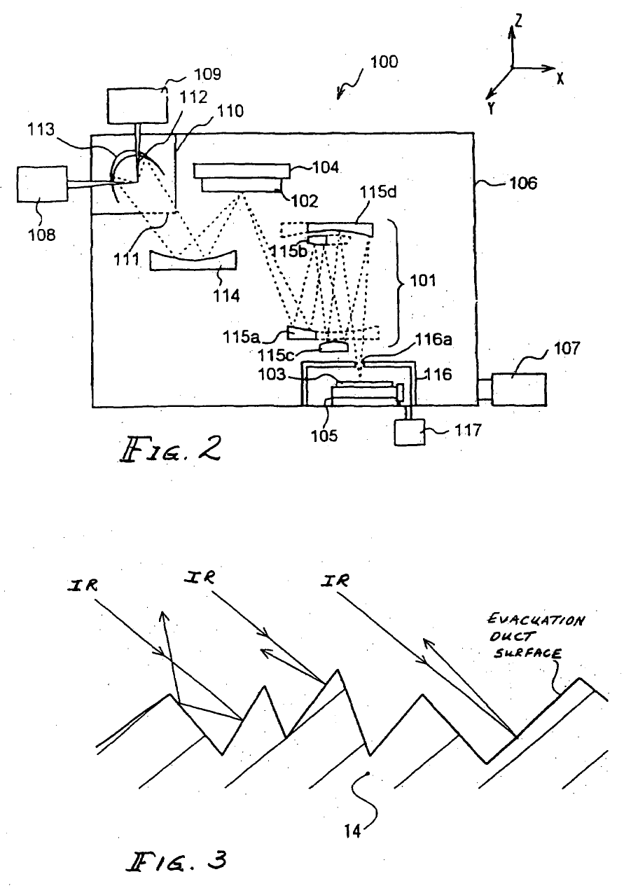

An exposure system according to this embodiment is shown in FIGS. 1 and 2. The exposure system of this embodiment is an EUV exposure system having a configuration as shown schematically in FIG. 2. The EUV exposure system 100 uses EUV light as an illumination light for making microlithographic exposures. The wavelength of EUV light is in the range 0.1 to 400 nm. In this embodiment EUV light having a wavelength from approximately 1 to 50 nm is used. For performing projection imaging, an imaging-optical system 101 is used as a projection-optical system. The imaging-optical system 101 images a pattern, defined by a reflective reticle 102, onto a wafer 103. The image actually formed on the wafer 103 is “reduced” (demagnified) relative to the pattern on the reticle 102. The reticle 102 is positioned using an electrostatic chuck (not shown) mounted on a downward-facing surface of a reticle stage 104. Meanwhile, the wafer 103 is mounted on and positioned using a wafer stage 105. Typically, step-scan exposures are performed using the system 100. The exposure system is placed in a clean room held within a prescribed temperature range. Also, the interior of the system 100 (e.g., space in which the imaging-optical system 101 is located) is controlled within a prescribed temperature range.

EUV light used as an exposure-illumination light is poorly transmitted through air, so the optical path through which the EUV light passes is contained in a first vacuum chamber 106 maintained at a desired vacuum level using a vacuum pump 107. The EUV light is generated by a laser-plasma X-ray source. The laser-plasma X-ray source comprises a laser 108 (acting as an excitive light source) and a xenon gas-supply device 109. The laser-plasma X-ray source is contained in a second vacuum chamber 110. EUV light generated by the laser-plasma X-ray source passes through a window 111 in the second vacuum chamber 110 to the first vacuum chamber 106.

A parabolic mirror 113 is positioned in proximity to a location at which a nozzle 112 of the xenon gas-supply device 109 discharges xenon gas. The parabolic mirror 113 constitutes a condensing optical system that condenses the EUV light generated by the plasma. The focal point of the parabolic mirror 113 is adjusted so as to be at or in close proximity to the location at which the nozzle 112 discharges xenon gas. EUV light from the plasma is reflected by a multilayer film on the reflective surface of the parabolic mirror 113, passes through the window 111 in the second chamber 110, and arrives at a condensing mirror 114. The condensing mirror 114 reflects and condenses the EUV light onto the reticle 102. As the EUV light is incident on the reticle 102, the EUV light irradiates a prescribed portion of the reticle 102. Thus, the illumination-optical system of this exposure system 100 comprises the parabolic mirror 113 and the condensing mirror 114.

The reticle 102 comprises a multilayer film that reflects incident EUV light and that includes an absorption-pattern layer configured to form a pattern. Thus, EUV light reflected by the reticle 102 is patterned according to the absorption-pattern layer. The patterned EUV light passes through the imaging-optical system 101 and arrives at the wafer 103.

The imaging-optical system 101 in the embodiment of FIG. 2 comprises four reflective mirrors, including a concave first mirror 115a, a convex second mirror 115b, a convex third mirror 115c, and a concave fourth mirror 115d. Each of the mirrors 115a-115d comprises a respective multilayer film that reflects incident EUV light.

EUV light reflected by the reticle 102 is reflected in succession by the first mirror 115a, the second mirror 115b, the third mirror 115c, and the fourth mirror 115d to form, on the surface of the wafer 103, a reduced (demagnified) image (reduced by a ratio of, e.g., 1/4, 1/5, or 1/6) of the reticle pattern. The imaging optical system 101 is telecentric on the image side (i.e., on the wafer side).

As noted, the reticle 102 is supported by a movable reticle stage 104 that is movable at least within the X-Y plane. The wafer 103 is supported by the wafer stage 105, which preferably is movable in the X, Y, and Z directions. To expose a “die” onto the wafer 103, EUV light passing through the illumination-optical system irradiates a prescribed area of the reticle 102. Meanwhile, the stages 104, 105 move the reticle 102 and wafer 103, respectively, at prescribed respective velocities (according to the reduction ratio) relative to the imaging-optical system 101. Thus, a prescribed exposure range (relative to the die) on the wafer 103 is exposed to the reticle pattern.

During exposure, it is preferable that the wafer 103 be situated in a wafer chamber behind a partition 116 to prevent gases arising from the resist on the surface of the wafer 103 from adversely affecting the mirrors 115a-115d of the imaging-optical system 101. The partition 116 defines an opening 116a, and EUV light from the mirror 115d passes through the opening 116a to irradiate the wafer 103. The space within the partition 116 is evacuated to a desired vacuum level using a vacuum pump 117. Thus, foreign particulate and gaseous matter is prevented from adhering to the mirrors 115a-115d or the reticle 102 during exposure, thereby preventing degradation of optical performance of these components.

Returning to FIG. 1, certain details of the exposure apparatus of this embodiment are shown. For convenience of explanation, FIG. 1 pertains to the wafer chamber containing a wafer and a wafer stage and to the evacuation system for the wafer chamber (corresponding to items 116 and 117, respectively, in FIG. 2). It will be understood that the depicted configuration can be applied with similar facility to other portions of the exposure system, such as, for example, a vacuum chamber containing a reticle and imaging-optical system and the associated evacuation system (corresponding to items 106 and 107, respectively, in FIG. 2).

More specifically, FIG. 1 depicts a vacuum chamber 11, a turbo pump 12, a mechanical pump 13, an evacuation duct 14, a duct-cooling device 15, a projection-optical system 16, a wafer 17, and a wafer stage 18. The wafer 17 and wafer stage 18 are accommodated within the vacuum chamber 11. Above the vacuum chamber 11 is an opening (not detailed) to guide EUV light from the projection-optical system 16 to the wafer 17. One end of the evacuation duct 14 is connected to the vacuum chamber 11 below the wafer stage 18. The other end of the evacuation duct 14 is connected to the suction opening of the turbo pump 12. The evacuation duct 14 is cooled by the duct-cooling device 15, which is connected to the duct by a liquid-coolant tube 15a.

The mechanical pump 13, used for achieving a desired rough vacuum level, is connected in series with the evacuation opening of the turbo pump 12. By driving these vacuum pumps 12 and 13, the interior of the vacuum chamber 11 can be held at a high-vacuum level of approximately 10⁻⁵ Pa. The turbo pump 12 is cooled by a pump-cooling device 19 connected to the pump 12 by a liquid-coolant tube 19a.

The evacuation duct 14 in this embodiment has an L-shaped configuration. The interior surfaces of the duct 14 are treated to impart a roughened property to the surfaces. An exemplary roughening treatment involves surface texturing to form innumerable (and very small) protrusions on the interior surface of the evacuation duct 14. Hence, the inner surface of the evacuation duct 14 constitutes a reflection-preventing surface that impedes reflection of infrared rays therefrom, as discussed below. The height of individual protrusions on the interior surfaces of the evacuation duct 14 (i.e., the surface roughness of the interior surfaces of the evacuation duct 14) are established with appropriate consideration being given to the wavelength of infrared rays whose reflection of which is to be prevented. In one example, not intending to be limiting, the protrusion heights on the interior surfaces of the evacuation duct 14 are in the range of approximately several micrometers to approximately several millimeters. One way of achieving this kind and degree of roughness is by threading or other machining of the interior surfaces of the evacuation duct 14. Another way involves mixing silica or any of various ceramic powders or the like with a base material and applying the resulting mixture to the interior surfaces of the evacuation duct 14. Any of various other techniques can alternatively be employed to form the protrusions.

During operation of the FIG. 1 device, the turbo pump 12 is cooled by the pump-cooling device 19 to prevent emission of infrared rays from the pump 12 itself. However, during operation of the turbo pump 12, infrared rays are emitted from the motor incorporated within the turbo pump. These infrared rays propagate in the evacuation duct 14 toward the vacuum chamber 11.

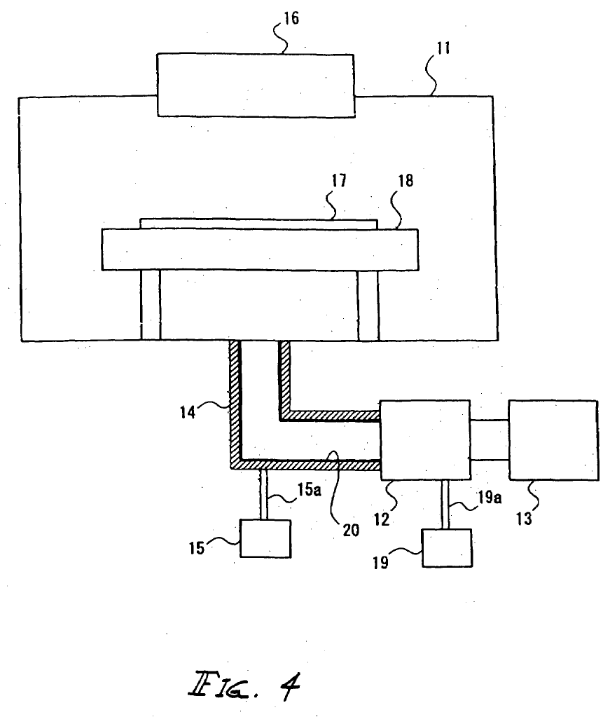

As noted above, the evacuation duct 14 has an L-shaped configuration, which blocks direct incidence of infrared rays from the turbo pump 12 to the vacuum chamber 11. Also, the interior surfaces of the evacuation duct 14 are treated, as described above, to prevent reflection of infrared rays incident thereon. This reflection prevention is achieved using the innumerable protrusions, described above. I.e., as shown in FIG. 3, infrared rays reflected by the interior surface of the evacuation duct 14 are strongly scattered by the irregularities formed by the protrusions. Through repetition of reflection and absorption accompanying this scattering, the amount of infrared radiation reaching the vacuum chamber 11 is sharply decreased. Also, the evacuation duct 14 is cooled by the duct-cooling device 15 to prevent the evacuation duct 14 from becoming a secondary heat source.

Thus, with this embodiment, the amount of infrared radiation from the turbo pump 12 entering the vacuum chamber 11 is sharply reduced, which greatly suppresses thermal deformation of the wafer 17 otherwise caused by incident infrared radiation from the turbo pump 12.

### Second Representative Embodiment

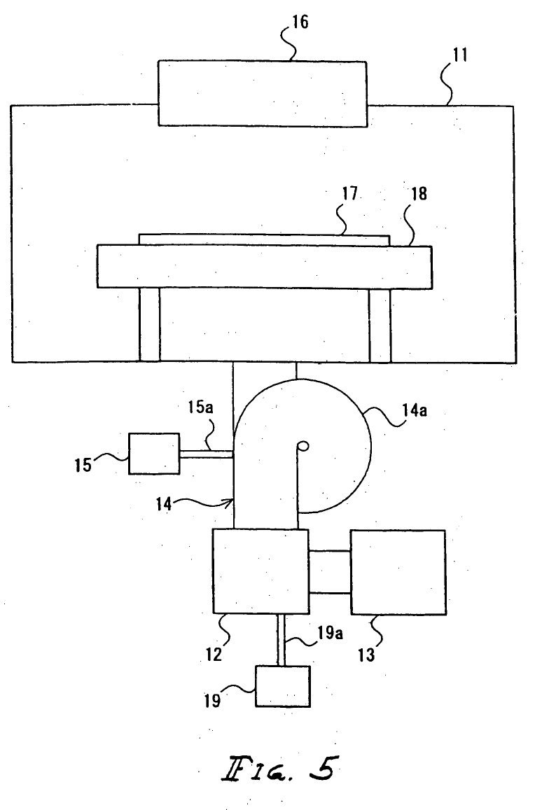

This embodiment is shown schematically in FIG. 4. In FIG. 4, components that are similar to corresponding components shown in FIG. 1 have the same reference numerals and are not described further.

In this embodiment a reflection-preventing film 20, formulated to prevent reflection of incident infrared rays, is situated (by forming or application) on the interior surfaces of the evacuation duct 14. The reflection-preventing film 20 can be formed of any of various known infrared reflection-preventing materials. For example, the reflection-preventing film 20 can be a thin film formed of a polymer material in which is dispersed gold black, carbon black, or a metal oxide. The evacuation duct 14 is cooled by a duct-cooling device 15 to prevent the evacuation duct 14 from being a secondary heat source. Using this embodiment, advantageous results are achieved that are substantially the same as achieved by the first representative embodiment.

### Third Representative Embodiment

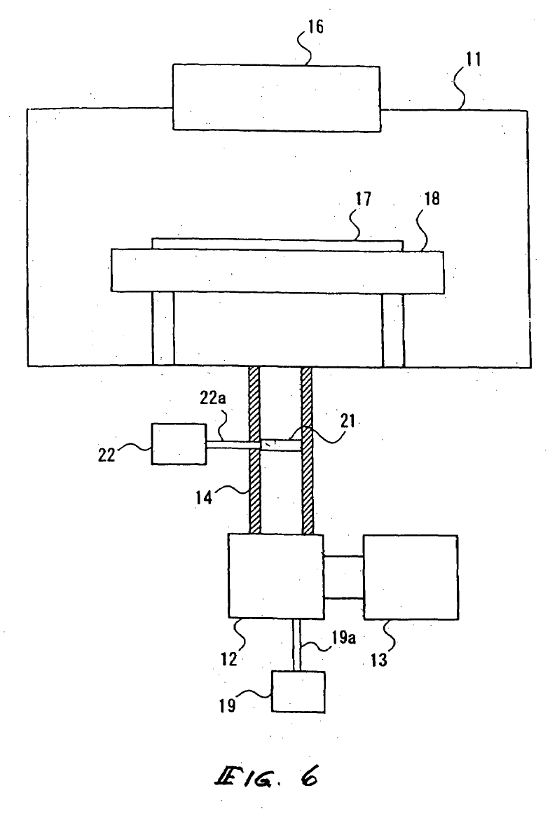

This embodiment is shown schematically in FIG. 5, in which components that are similar to corresponding components shown in FIG. 4 have the same reference numerals and are not described further. In this embodiment the evacuation duct 14 of FIG. 4 has a wrap-around configuration 14a, formed by bending and wrapping-around the middle portion of the evacuation duct 14. The wrapped-around portion forms an infrared-ray trap. The evacuation duct 14 is cooled by a duct-cooling device 15. Since, in this embodiment, passage of infrared rays from the turbo pump 12 into the vacuum chamber 11 is blocked, advantageous results as achieved by the first embodiment are obtained.

### Fourth Representative Embodiment

This embodiment is shown schematically in FIG. 6, in which components that are similar to corresponding components shown in FIG. 4 have the same reference numerals and are not described further. In this embodiment a shielding member 21, used for shielding infrared rays, is positioned in an intermediate portion of the evacuation duct 14. The shielding member 21 is cooled by a cooling device 22 connected by a liquid-coolant tube 22a. The turbo pump 12 is positioned directly below the wafer stage 18, and the evacuation duct 14 has no curved portions.

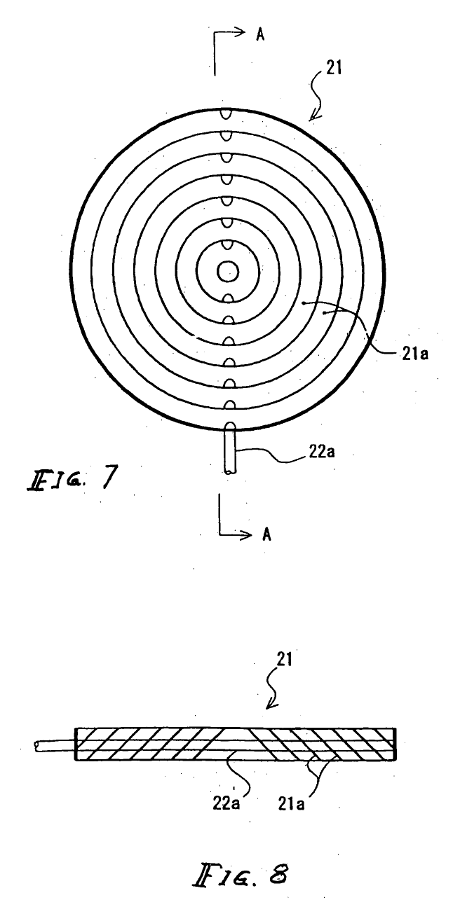

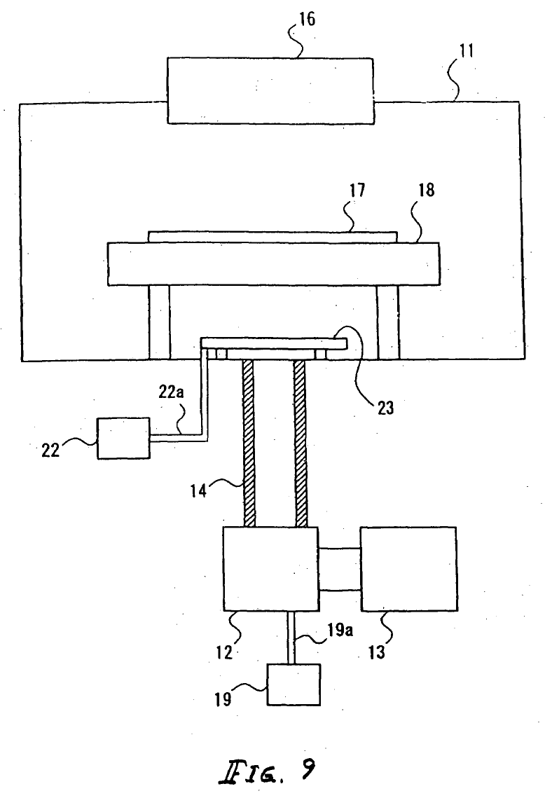

FIGS. 7 and 8 show an exemplary configuration of the shielding member 21. The depicted configuration has a plate shape, formed by concentrically positioning multiple circular shielding vanes 21a of different respective diameters. The shielding member 21 has an outside diameter or transverse dimension suitable for allowing accommodation of the shielding member inside the evacuation duct 14. The liquid-coolant tube 22a extends through each of the shielding vanes 21a of the shielding member 21.

Each of the shielding vanes 21a is formed such that the diameter on the side of one end expands outward compared to the diameter on the side of the other end. The angle of expansion from the side of one end to the side of the other end for each of the shielding vanes 21a desirably is substantially the same for each of the vanes. Seen from a direction perpendicular to the shielding member 21 (from above or from below in FIG. 8), the side on one end of a shielding vane 21a overlaps with the side on the other end of the adjacent shielding vane 21a. This louver-like overlap of the shielding vanes with each other allows the shielding member 21 to block passage of infrared rays that otherwise would pass through the shielding member. Between the angled adjacent vanes 21a are gas-passages that allow gas flowing in the evacuation duct 14 to pass through the shielding member 21. The shielding member 21 is cooled by the cooling device 22 to prevent the shielding member 21 being a secondary heat source.

Using the fourth embodiment, advantageous results can be achieved as obtained using the first embodiment. The configuration of the shielding member 21 shown in FIGS. 7 and 8 is exemplary only; appropriate modifications, such as to the arrangement of the shielding vanes 21a, can be made according to design requirements.

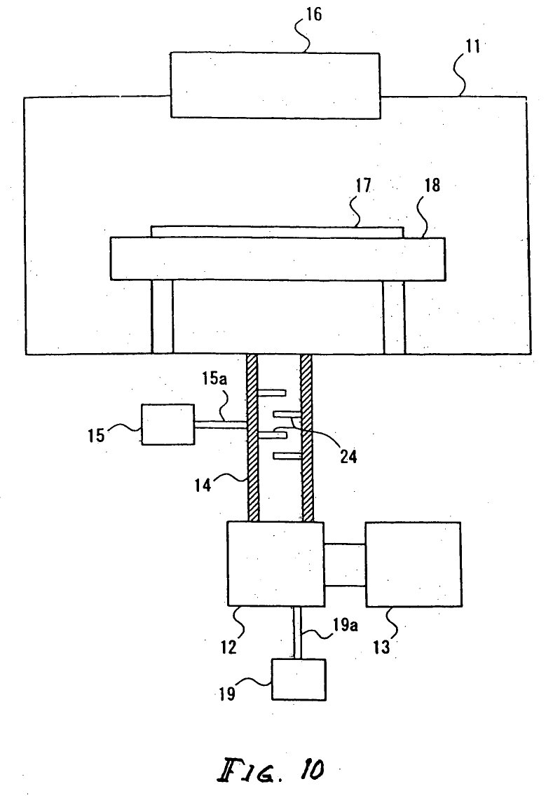

A modification of the FIG.-6 embodiment is shown in FIG. 9, in which a shielding member 23 is situated at the inlet of the evacuation duct 14 in the vacuum chamber 11. As with the shielding member 21 in the FIG.-6 embodiment, the shielding member 23 in FIG. 9 is cooled by a cooling device 22. The shielding member 23 is sized to achieve adequate shielding of the evacuation duct 14. Desirably, the shielding member 23 is configured as a plate-like member having no openings. A clearance is provided between the shielding member 23 and the inlet of the evacuation duct 14, thereby providing a gas passageway. Alternatively, if the shielding member 23 has a configuration similar to the shielding member 21 shown in FIGS. 7 and 8, then the shielding member 21 can be installed without a clearance at the inlet of the evacuation duct 14.

### Fifth Representative Embodiment

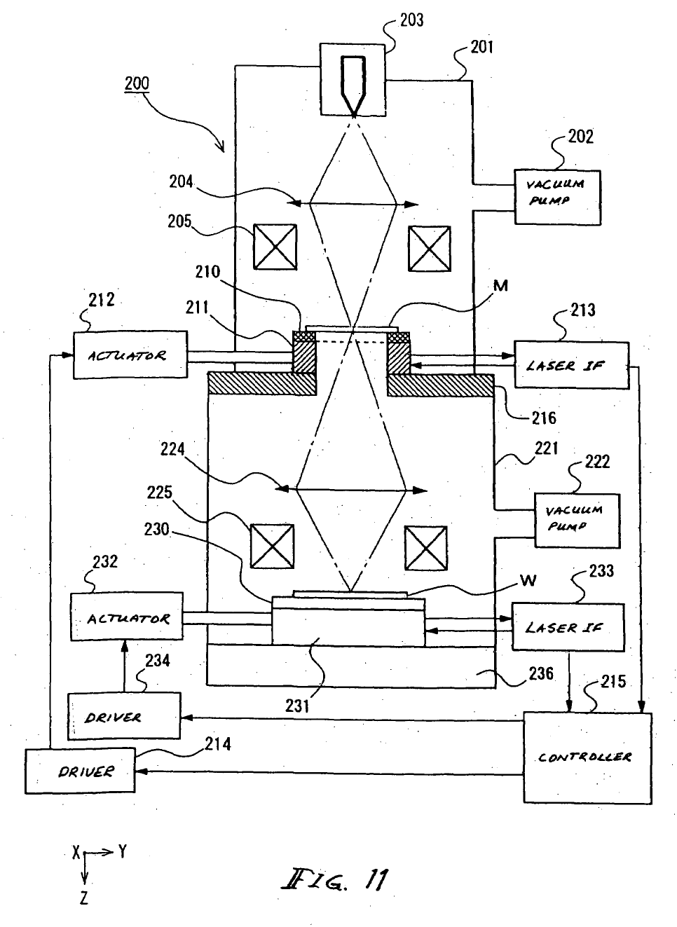

This embodiment is shown in FIG. 10, in which a shielding structure comprises multiple, partially overlapping, protruding pieces situated within the evacuation duct 14. Specifically, the protruding pieces 24 extend from the interior walls of the evacuation duct 14. The protruding pieces 24 are positioned at different respective positions in the extension direction of the evacuation duct 14. Each protruding piece 24 partially shields the evacuation duct 14. The protruding pieces 24 are situated so that any one of them shields an area not shielded by an adjacent protruding piece, and so that they collectively shield the entire evacuation duct 14. In the example of FIG. 10, each of the protruding pieces 24 shields over half of the transverse area of the evacuation duct 14, and the multiple protruding pieces 24 effectively interdigitate to form the shielding structure. Desirably, each of the protruding pieces 24 is cooled using a cooling device 15, connected to the protruding pieces by a duct 15a.

As can be seen in FIG. 10, clearance is provided between each of the protruding pieces 24. Consequently, the protruding pieces 24 do not completely block the evacuation duct 14 with respect to passage of gas in the evacuation duct 14. Thus, this embodiment achieves advantageous results substantially similar to those achieved by the first representative embodiment.

### EXAMPLE

This example pertains to an exposure apparatus having the configuration of the fourth representative embodiment, as shown in FIG. 6. The turbo pump 12 is placed one meter directly below the wafer stage 18 in the EUV exposure system. The shielding member 21 is positioned within the evacuation duct 14. The turbo pump 12 operated to provide an evacuation rate of 250 L/min. The target controlled temperature of the wafer 17 was set to 23° C., and the shielding member 21 was cooled to 23° C. Even when the wafer 17 was left for 10 minutes in the vacuum chamber 11, the increase in wafer temperature was held to 0.1° C. or less.

### Comparison Example

In a comparison example for the example above, vacuum evacuation was performed under conditions similar to those in the example, except that the shielding member 21 was not present in the duct 14. While monitoring the temperature of a wafer 17 left for ten minutes in the vacuum chamber 11, the wafer temperature increased markedly, to 23.9° C.

The foregoing embodiments were described in the context of EUV exposure systems. But, this is not intended to be limiting in any way. For example, the exposure systems can be CPB exposure systems. In this regard, a CPB exposure system 200, comprising one of the subject embodiments is shown schematically in FIG. 11. The system 200 is placed in a clean room held in a prescribed temperature range, and the interior of the system is also controlled within a prescribed temperature range. On the upper portion of the CPB exposure system 200 is a first lens barrel (vacuum chamber) 201. A vacuum pump 202 is connected to the first lens barrel 201 to achieve vacuum-evacuation of the interior of the first lens barrel 201.

On the upper portion of the first lens barrel 201 is an electron gun 203. The electron gun 203 emits an electron beam in a downward direction. Downstream of the electron gun 203 are, in order, a condenser lens 204, an electron-beam deflector 205, and a reticle or mask M. The electron beam emitted from the electron gun 203 is converged by the condenser lens 204. The electron beam is scanned in the horizontal direction by the deflector 205 so that each of multiple subfields of the mask M within the field of the optical system is irradiated by the beam.

The mask M is held, by electrostatic clamping or the like, by a chuck 210 provided on the upper portion of the mask stage 211. The mask stage 211 is mounted on a platen 216.

The mask stage 211 is connected to an actuator 212, shown on the left in the figure. The actuator 212 is connected via a driver 214 to a controller 215. On one side of the mask stage 211 (on the right in the figure) is a laser interferometer 213. The laser interferometer 213 is connected to the controller 215.

Downstream of the platen 216 is positioned the wafer chamber (second vacuum chamber) 221. On one side (on the right in the figure) of the wafer chamber 221, a vacuum pump 222 is connected to perform vacuum-evacuation of the interior of the wafer chamber 221. Located within the wafer chamber 221 are, from upstream, a condenser lens 224, a deflector 225, and a wafer W.

The electron beam, having passed through the mask M, is converged by the condenser lens 224. After passage through the condenser lens 224, the electron beam is deflected by the deflector 225 as required to form an image of the mask M at a prescribed location on the wafer W.

The wafer W is held, by electrostatic clamping or the like, by a chuck 230 mounted to the upper portion of the wafer stage 231. The wafer stage 231 is mounted on a platen 236. The wafer stage 231 is connected to an actuator 232, shown on the left in the figure. The actuator 232 is connected via a driver 234 to the controller 215. On one side of the wafer stage 231 (the right side in the figure) is a laser interferometer 233. The laser interferometer 233 is connected to the controller 215.

The controller 215 uses the corresponding driving devices 212, 232 to drive the mask stage 211 and wafer stage 231 to target positions during exposure, based on position information obtained by the laser interferometers 213, 233.

In this CPB exposure system, any of the embodiments described above can be incorporated in the vacuum chamber 201 and vacuum pump 202 and in the vacuum chamber 221 and vacuum pump 222.

The embodiments described above are intended to be exemplary only, and any of them can be combined arbitrarily as required or desired. For example, the shielding member described in the fourth embodiment may be positioned in stages. Further, as described above, in EUV exposure systems and CPB exposure systems, any of the embodiments can be applied to vacuum chambers other than the wafer chamber. In this latter case, by blocking infrared rays incident on the vacuum chamber from a vacuum pump, thermal deformation of the mask or reticle, as well as thermal deformation of other optical elements, are suppressed.

The invention can be implemented in various forms without deviating from the spirit or from the principal characteristics thereof. Hence, the above-described embodiments are merely illustrations in all respects, and should not be interpreted as limiting in any way. This invention is as described in the claims, and is not limited by the specification. Moreover, the scope of the invention extends to all modifications and alterations which are equivalent to the claims.

What is claimed is:

1. An exposure system, comprising:
a chamber containing exposure components;
a pump configured to evacuate an atmosphere in the chamber to a desired vacuum level;
an evacuation duct having an inlet connected to the chamber and an outlet connected to the pump so as to conduct atmosphere from the chamber being evacuated by the pump; and
an infrared-radiation propagation-inhibiting device associated with at least one of the evacuation duct and chamber and being configured at least to inhibit propagation of infrared radiation from the pump into the chamber.

2. The exposure system of claim 1, wherein the infrared-radiation propagation-inhibiting device is configured to block propagation of infrared radiation from the pump into the chamber.

3. The system of claim 2, wherein the infrared-radiation propagation-inhibiting device comprises an infrared-radiation-blocking shield.

4. The system of claim 3, wherein the shield is situated in the evacuation duct.

5. The system of claim 3, wherein the shield is situated in the chamber.

6. The system of claim 3, wherein the shield is situated in or associated with the inlet.

7. The system of claim 1, wherein the pump comprises a dry pump.

8. The system of claim 1, wherein the infrared-radiation propagation-inhibiting device is situated and configured to inhibit propagation of infrared radiation from the pump to the chamber without significantly obstructing flow of gas from the chamber to the pump through the evacuation duct.

9. The system of claim 8, wherein:
the evacuation duct comprises an interior surface; and
the infrared-radiation propagation-inhibiting device comprises multiple shield portions attached to the interior surface of the evacuation duct and projecting into the evacuation duct from the interior surfaces.

10. The system of claim 9, wherein the multiple shield portions interdigitate with each other in the evacuation duct.

11. The system of claim 1, wherein the infrared-radiation propagation-inhibiting device comprises a gas-flow portion and a shielding portion, the gas-flow portion being situated and configured to allow flow of gas from the chamber to the pump, and the shielding portion being situated and configured to shield the evacuation duct from transmitting infrared radiation from the pump to the chamber.

12. The system of claim 11, further comprising a cooling device coupled to the shielding portion and configured to cool the shielding portion.

13. The system of claim 1, further comprising a cooling device coupled to the evacuation duct.

14. The system of claim 1, wherein the infrared-radiation propagation-inhibiting device comprises a curved portion of the evacuation duct, the curved portion being configured to block direct incidence of the infrared radiation through the duct from the pump to the chamber.

15. The system of claim 1, wherein:
the evacuation duct comprises an interior surface; and
the infrared-radiation propagation-inhibiting device comprises multiple protrusions formed on the interior surface and configured to scatter infrared radiation incident on the protrusions.

16. The system of claim 15, wherein the protrusions comprise surface-roughening protrusions.

17. The system of claim 1, wherein:
the evacuation duct comprises an interior surface; and
the infrared-radiation propagation-inhibiting device comprises an anti-reflective film on the interior surface, the film being formulated and configured to prevent reflection of infrared radiation incident on the film.

18. The system of claim 17, further comprising wherein the evacuation duct further comprises a duct-cooling device.

19. The system of claim 1, configured as an EUV exposure system.

20. The system of claim 1, configured as a CPB exposure system.

21. An exposure system, comprising:
chamber means for containing exposure components;
pump means for evacuating the chamber to a desired vacuum level;
duct means for conducting gas from the chamber means to the pump means; and
means for inhibiting propagation of infrared radiation from the pump into the chamber.

22. A lithographic exposure method, comprising:
placing a substrate in a chamber containing exposure components by which the substrate can be exposed to an energy beam;
coupling the chamber via an evacuation duct to a vacuum pump;
using the vacuum pump, evacuating gas from the chamber through the evacuation duct to achieve a desired subatmospheric pressure in the chamber; and
inhibiting propagation of infrared radiation, produced by the vacuum pump, through the evacuation duct to the chamber.

23. The method of claim 22, wherein propagation of the infrared radiation is inhibited while gas is being conducted from the chamber to the vacuum pump.

24. A lithographic exposure method, comprising:
placing a substrate in a chamber containing exposure components by which the substrate can be exposed to an energy beam;
coupling the chamber via an evacuation duct to a vacuum pump;
using the vacuum pump, evacuating gas from the chamber through the evacuation duct to achieve a desired subatmospheric pressure in the chamber; and
controlling a temperature of at least the substrate in the chamber by controlling incursion of infrared radiation, produced by the vacuum pump, through the evacuation duct into the chamber.

25. The method of claim 24, wherein the temperature is controlled by inhibiting propagation of at least a portion of the infrared radiation, produced by the vacuum pump, through the evacuation duct into the chamber.

26. The method of claim 24, further comprising cooling the evacuation duct.
